(19) United States
(12) Patent Application Publication
(10) Pub. No.: US 2015/0224575 A1
(43) Pub. Date: Aug. 13, 2015

(54) SINTER MOLD MATERIAL, SINTERING AND MOLDING METHOD, SINTER MOLD OBJECT, AND SINTERING AND MOLDING APPARATUS

(71) Applicant: SEIKO EPSON CORPORATION, Tokyo (JP)

(72) Inventor: Koki HIRATA, Matsumoto (JP)

(21) Appl. No.: 14/601,952

(22) Filed: Jan. 21, 2015

(30) Foreign Application Priority Data
Feb. 7, 2014 (JP) 2014-022002

(51) Int. Cl. B22F 1/00; B22F 3/105; C04B 35/634; B22F 3/00; B28B 1/00; B28B 11/24

(52) U.S. Cl. CPC B22F 1/0059; B28B 1/001; B28B 11/243; C04B 35/63416; C04B 35/63424; C04B 35/63436; C04B 35/63444; C04B 35/63408; C04B 35/63404; B22F 3/003; B22F 3/1055; B22F 2001/0066; B33Y 10/00

(57) ABSTRACT

A sintering and molding method includes forming a fluid mold material by heating a sinter mold material, which includes inorganic particles, a binder material and a binder material which bond together the inorganic particles, to a temperature equal to or more than the melting points of the binder materials, forming a mold layer by spreading the fluid mold material, layering a mold layer, applying UV ink to a desired region on the mold layer, forming a mold cross sectional pattern by curing the UV ink which is applied to a desired region on the mold layer, finishing a mold object by removing a region, where the UV ink is not applied, in the mold layer, carrying out heat treatment on the mold object at a temperature which is less than the initial temperature of thermal decomposition of the binder material, and carrying out sintering treatment on the mold object.

### CROSS-REFERENCE TO RELATED APPLICATIONS

This application claims priority to Japanese Patent Application No. 2014-022002 filed on Feb. 7, 2014. The entire disclosure of Japanese Patent Application No. 2014-022002 is hereby incorporated herein by reference.

### BACKGROUND

1. Technical Field

The present invention relates to a sinter mold material, a sintering and molding method, a sinter mold object, and a sintering and molding apparatus.

2. Related Art

There is a layer molding method as one method for molding where a solid model (a mold object) with a three dimensional shape is formed. As a layering and molding method, there are proposed, for example, a light molding method where each layer of a cross section of a mold object is formed by selectively curing a photocurable resin using a laser while layering, a powder sintering method where each layer is formed by selectively fusing and solidifying a powder material using a laser while layering, a molten depositing method where each layer is formed due to a thermoplastic material being deposited by being heated and pressed out from a nozzle, a sheet layering method of forming by a sheet material such as paper being cut into the cross sectional shapes of a model and being layered and bonded, and the like.

It is disclosed in Japanese Patent No. 2729110 that “a powder material which includes ceramics, a metal, or the like is coated in a layer form. Next, a liquid binding agent which binds together the powder material is discharged onto the layer of the power material using, for example, an ink jet liquid droplet discharge apparatus. A mold object which corresponds to a two dimensional cross sectional layer is formed by the liquid binding agent which penetrates into the spaces between the powder material joining together the powder material. A mold object which has a three dimensional structure is manufactured due to coating of the powder material and discharging of the liquid binding agent are alternately repeated in this manner”.

The mold object manufacturing method in Japanese Patent No. 2729110 is a method where the liquid binding agent connects together the powder material and is different to a powder sintering method, where each layer is formed by selectively fusing and solidifying a metal material using a laser, in an aspect where the powder material is joined together. The strength of the mold object in manufacturing methods, where the powder material is connected together using a liquid binding agent as in Japanese Patent No. 2729110, is typically inferior. On the other hand, contraction of the dimensions of the mold object are considerable and it is easy for changes in shape and breakages to occur when sintering is introduced in order to improve the joining together of the powder material in the manufacturing method as in Japanese Patent No. 2729110. That is, there are problems in the mold object manufacturing method in Japanese Patent No. 2729110 in that it is not possible to stabilize forming of a high precision mold object with greater strength.

### SUMMARY

The present invention is carried out in order to solve at least a portion of the problems described above and is able to be realized as the following applied examples and embodiments.

A sinter molding material according to the present applied example, which is used a molding method which includes applying liquid droplets to a desired region of the sinter mold material and curing the liquid droplets, includes first inorganic particles, a first thermoplastic binder which bonds together the first inorganic particles, and a second thermoplastic binder which bonds together the first inorganic particles, and an initial temperature of thermal decomposition of the second thermoplastic binder is higher than an initial temperature of thermal decomposition of the first thermoplastic binder.

According to the present applied example, the sinter mold material includes the first thermoplastic binder and the second thermoplastic binder which bond together the first inorganic particles. Since the initial temperature of thermal decomposition of the second thermoplastic binder is higher than the initial temperature of thermal decomposition of the first thermoplastic binder, it is possible to provide heating with a wider temperature width with regard to the sinter mold material during molding of the sinter mold object by degreasing and sintering the mold object.

The sinter molding material according to the applied example described above where the initial temperature of thermal decomposition of the first thermoplastic binder is 50° C. or more and less than 350° C.

According to the present applied example, since the initial temperature of thermal decomposition of the first thermoplastic binder is 50° C. or more and less than 350° C., it is possible for degreasing where the first thermoplastic binder is the target to progress by heating the sinter mold material within a temperature range which exceeds the initial temperature of thermal decomposition of the first thermoplastic binder.

The sinter molding material according to the applied example described above where the initial temperature of thermal decomposition of the second thermoplastic binder is 350° C. or more and 750° C. or less.

According to the present applied example, since the initial temperature of thermal decomposition of the second thermoplastic binder is 350° C. or more and 750° C. or less, it is possible for degreasing where the second thermoplastic binder is the target to progress by heating the sinter mold material within this temperature range.

The sinter molding material according to the applied example described above where it is preferable that the first thermoplastic binder be polyvinyl alcohol, polyvinyl pyrrolidone, poly(meth)methyl acrylate, polyvinyl chloride, ethylene and vinyl acetate copolymer, or polycaprolactone diol.

According to the present applied example, it is possible for degreasing where the first thermoplastic binder is the target to progress by heating the sinter mold material at a temperature which exceeds the temperature of the initial temperature of thermal decomposition (from 50° C. to 350° C.) of polyvinyl alcohol, polyvinyl pyrrolidone, poly(meth)methyl acrylate, polyvinyl chloride, ethylene and vinyl acetate copolymer, or polycaprolactone diol.

The sinter molding material according to the applied example described above where it is preferable that the second thermoplastic binder be polyethylene, polypropylene, polytetrafluoroethylene, or polybenzimidazole.

According to the present applied example, it is possible for degreasing where the second thermoplastic binder is the target to progress by heating the sinter mold material at a temperature which exceeds the temperature of the initial temperature of thermal decomposition (from 350° C. to 750° C.) of polyethylene, polypropylene, polytetrafluoroethylene, or polybenzimidazole.

The sinter molding material according to the applied example described above where the first inorganic particles are metal particles.

According to the present applied example, since the first inorganic particles are metal particles, it is possible to mold a sinter mold object which is metal.

The sinter molding material according to the applied example described above where the first inorganic particles are ceramic particles.

According to the present applied example, since the first inorganic particles are ceramic particles, it is possible to mold a sinter mold which is ceramic.

The sinter molding material according to the applied example described above where a solvent is included.

By the solvent being included in the sinter mold material as in the present applied example, it is possible to more easily obtain the sinter mold material in a paste form where the first inorganic particles are uniformly dispersed.

A sintering and molding method according to the present applied example includes forming a fluid mold material by heating a sinter mold material, which includes first inorganic particles, a first thermoplastic binder which bonds together the first inorganic particles, and a second thermoplastic binder which bonds together the first inorganic particles and which has an initial temperature of thermal decomposition which is higher than an initial temperature of thermal decomposition of the first thermoplastic binder, to a temperature which is equal to or more than a melting point of the first thermoplastic binder and a melting point of the second thermoplastic binder, forming a mold layer by spreading the fluid mold material, layering the mold layer, applying liquid droplets to a desired region on the mold layer, forming a mold cross sectional pattern by curing the liquid droplets which are applied to the desired region on the mold layer, finishing a mold object by removing a region, where the liquid droplets are not applied, in the mold layer, carrying out heat treatment on the mold object at a temperature which is less than the initial temperature of thermal decomposition of the second thermoplastic binder, and carrying out sintering treatment on the mold object.

The sintering and molding method according to the present applied example includes forming the fluid mold material by heating the sinter mold material, which includes the first inorganic particles and the first thermoplastic binder and the second thermoplastic binder which bond together the first inorganic particles, to a temperature which is equal to or more than the melting point of the first thermoplastic binder and the melting point of the second thermoplastic binder. It is possible to suppress changes in shape and breakages since the sinter mold material which is configured by the first inorganic particles includes the first thermoplastic binder which bonds together the first inorganic particles and the second thermoplastic binder which has a higher initial temperature of thermal decomposition than the first thermoplastic binder.

The sintering and molding method according to the applied example described above where the liquid droplets include second inorganic particles.

According to the present applied example, the liquid droplets which are applied to a desired region of the mold layer include the second inorganic particles. That is, since the liquid droplets which include the second inorganic particles are applied to a desired region of the mold layer which is formed in the desired cross sectional shape of the mold object, the mold object which is sintered due to degreasing is configured to include the second inorganic particles in addition to the first inorganic particles. That is, it is possible to obtain the mold object where the filling ratio of the inorganic particles is higher compared to a mold object which is configured only by the first inorganic particles.

The sintering and molding method according to the applied example described above where the second inorganic particles are metal particles which are the same as the first inorganic particles.

According to the present applied example, it is possible to the sinter mold object, for which the effects described above are obtained, using the same metal material.

The sintering and molding method according to the applied example described above where the second inorganic particles are ceramic particles which are the same as the first inorganic particles.

According to the present applied example, it is possible to the sinter mold object, for which the effects described above are obtained, using the same ceramic material.

A sintering and molding apparatus according to the present applied example is provided with a heating section configured to form a fluid mold material by heating a sinter mold material, which includes first inorganic particles, a first thermoplastic binder which bonds together the first inorganic particles, and a second thermoplastic binder which bonds together the first inorganic particles and which has an initial temperature of thermal decomposition which is higher than the initial temperature of thermal decomposition of the first thermoplastic binder, to a temperature which is equal to or more than a melting point of the first thermoplastic binder and a melting point of the second thermoplastic binder, a spreading section configured to form a mold layer by spreading the fluid mold material, a molding section configured to layer the mold layer, a drawing section configured to apply liquid droplets to a desired region on the mold layer which is layered, and a curing section configured to form a mold cross sectional pattern by curing the liquid droplets which are applied to the desired region on the mold layer.

The sintering and molding apparatus according to the present applied example is provided with the heating section which forms the fluid mold material by heating the sinter mold material, which includes the first inorganic particles and the first thermoplastic binder and the second thermoplastic binder which bond together the first inorganic particles, to a temperature which is equal to or more than the melting point of the first thermoplastic binder and the melting point of the second thermoplastic binder. It is possible to suppress changes in shape and breakages since the sinter mold material which is configured by the first inorganic particles includes the first thermoplastic binder which bonds together the first inorganic particles and the second thermoplastic binder which has a higher initial temperature of thermal decomposition than the first thermoplastic binder.

The sintering and molding apparatus according to the applied example described above further provided with a finishing section configured to finish the mold object by removing a region, where the liquid droplets are not applied, in the mold layer and a sintering section configured to carry out heating and sintering treatment on the mold object.

The sintering and molding apparatus according to the present applied example is provided with the finishing section which finishes the mold object by removing a region, where the liquid droplets are not applied, in the mold layer and the sintering section which carries out degreasing and sintering treatment on the mold object. It is possible to finish the mold object by forming a desired cross sectional shape of the mold object and removing a region, where the liquid droplets are not applied, in the mold layer which is layered due to the desired region of the mold layer which is layered being cured.

A sinter mold object according to the present applied example is molded using the sinter mold material which is described as an example in any of applied example 1 to applied example 8.

The sinter mold object which is molded using the sinter mold material described in the applied examples described above is proposed as a sinter mold object with higher precision on the basis of more stable production and more stable quality.

A sinter mold object according to the present applied example is molded using the sintering and molding method which is described as an example in any of applied example 9 to applied example 12.

The sinter mold object which is molded using the sintering and molding material described in the applied examples described above is proposed as a sinter mold object with higher precision on the basis of more stable production and more stable quality.

A sinter mold object according to the present applied example is configured to include first inorganic particles which are included beforehand in a sinter mold material which is to be layered and second inorganic particles which are included in liquid droplets which are applied to the sinter mold material which is layered.

According to the present applied example, the sinter mold object is configured to include the first inorganic particles which are included beforehand in the sinter mold material which is to be layered and the second inorganic particles which are included in the liquid droplets which are applied to the sinter mold material which is layered. That is, since the sinter mold object is configured to include the second inorganic particles in addition to the first inorganic particles, it is possible to obtain the sinter mold object where the filling ratio of the inorganic particles is higher compared to a sinter mold object which is configured only by the first inorganic particles.

### BRIEF DESCRIPTION OF THE DRAWINGS

Referring now to the attached drawings which form a part of this original disclosure:

FIG. 1 is a conceptual diagram illustrating a state of a mold material according to embodiment 1 at room temperature;

FIG. 2 is a schematic diagram for describing a molding apparatus according to embodiment 1;

FIG. 3 is a conceptual diagram illustrating a situation where liquid droplets are applied to a desired region of a mold layer; and

FIG. 4 is a conceptual diagram illustrating a situation where liquid droplets are applied to a desired region of a mold layer according to embodiment 2.

### DETAILED DESCRIPTION OF EXEMPLARY EMBODIMENTS

Embodiments which formulate the present invention will be described below with reference to the drawings. Below is one embodiment of the present invention and the embodiment does not limit the present invention. Here, in order for the description to be easy to understand, there are cases the dimensions in the following diagrams are different to the actual dimensions.

### Embodiment 1

As embodiment 1, a “sinter mold material”, a “sintering and molding apparatus”, and a “sintering and molding method” which uses the sinter mold material and the sintering and molding apparatus will be described with respect to layer molding as one technique of molding a three dimensional solid model (a sinter mold object). As the method for layer molding, a method is used where a mold object is formed by selectively applying liquid droplets using an ink jet system to a thin layer which is configured by a sinter mold material which is to be formed into the cross sectional shape of the mold object and consecutively layering the portions where the liquid droplets are applied while curing.

Below, the details of this will be described.

### Sinter Mold Material

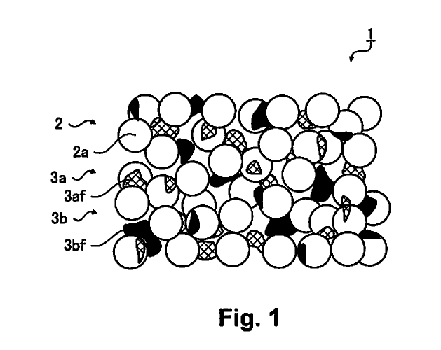

FIG. 1 is a conceptual diagram illustrating a state of a sinter mold material 1 according to an embodiment at room temperature (15° C. to 25° C.).

The sinter mold material 1 is a material (principal component) which is used when molding a three dimensional solid model (a sinter mold object) using a layer molding method and layers (referred to below as mold layers), which are for forming each layer which becomes the base for a sinter mold object, that is, each cross sectional shape of the mold object, are formed using the sinter mold material 1.

The sinter mold material 1 is configured using a powder material 2 which is formed from “first inorganic particles” which are a powder, a binder material 3a which is a “first thermoplastic binder”, a binder material 3b which is a “second thermoplastic binder”, and the like.

### Powder Material

The powder material 2 is a main constituent material of the sinter mold object which is formed using the sinter mold material 1.

The powder material 2 is configured as an aggregate of the inorganic particles 2a which are the “first inorganic particles”.

It is possible to use metal particles or ceramic particles as the inorganic particles 2a. It is preferable that the inorganic particles 2a have substantially a spherical shape where the average particle diameter is 0.1 μm or more and 30 μm or less and it is more preferable that the average particle diameter is 1 μm or more and 15 μm or less. In addition, it is preferable for the inorganic particles 2a to be closer to a true spherical shape. Due to this, controllability relating to the shape of the sinter mold object and, in particular, controllability of the shape on the sides and corner portions which define the outer shape of the sinter mold object is improved.

In addition, it is preferable that the particle diameter of the inorganic particles 2a be equal to or less than the average thickness of the mold layers which are formed using the sinter mold material 1 and it is more preferable that the particle diameter of the inorganic particles 2a be half or less of the average thickness of the mold layers. Due to this, it is possible to improve the volume filling ratio of the inorganic particles 2a in the mold layers and to improve the mechanical strength of the sinter mold object.

In addition, it is preferable that the powder material 2 includes the inorganic particles 2a with particles diameters which are different to each other in the range of the particles diameter described above. Here, the distribution of the particles diameters of the inorganic particles 2a may be a distribution which is close to a Gaussian distribution (a normal distribution) or may be a distribution (a one-sided distribution) such that the greatest number in the particle diameter distribution is on the largest diameter side or the smallest diameter side.

In a case where the particle diameters of the inorganic particles 2a are a single value, the volume filling ratio using the inorganic particles 2a when forming the sinter mold object does not exceed 69.8% which is the theoretical value when filling with maximum density and the filling ratio is approximately 50% to 60% in practice. In contrast to this, if the powder material 2 includes the inorganic particles 2a with particles diameters which are different to each other (where the particles diameters are distributed within a range), the volume filling ratio is improved due to, for example, the inorganic particles 2a where the particle diameter is relative small being arranged in the spaces which are formed by the inorganic particles 2a which have a relatively large particle diameter. Due to this, it is possible to improve the mechanical strength of the sinter mold object.

A stainless steel alloy powder is used in the powder material 2 (the inorganic particles 2a) as a preferred example. Here, the powder material 2 is not limited to a stainless steel alloy powder and other metal alloy powders such as a carbonyl iron powder or a titanium alloy powder, intermetallic compound powders such as titanium aluminum, or the like may be used. In addition, in the case of a ceramic powder, alumina powder, zirconia powder, or the like may be used.

The binder materials 3a and 3b are thermoplastic polymer compounds and have a function of adhering together the inorganic particles 2a when the powder material 2 and the binder materials 3a and 3b are mixed in the sinter mold material 1 and the inorganic particles 2a are substantially uniformly dispersed. As shown in FIG. 1, when the powder material 2 and the binder materials 3a and 3b are mixed together so as to be substantially uniformly dispersed, the binder materials 3a and 3b bond to the inorganic particles 2a as, for example, binder flakes 3af and 3bf in flake form.

### Binder Material

For example, polycaprolactone diol, where the melting point is 55° C. to 58° C. and the initial temperature of thermal decomposition is 200° C., is used as the binder material 3a as a preferred example.

The binder material 3a is not limited to polycaprolactone diol, any binder with thermoplasticity as a solid at room temperature and where the initial temperature of thermal decomposition is 50° C. or more and less than 350° C. is sufficient, and, for example, an ethylene-vinyl acetate copolymer or the like may be used. The melting point of an ethylene-vinyl acetate copolymer is 50° C. to 100° C. and the initial temperature of thermal decomposition is approximately 250° C.

The binder material 3a is a solid such as a wax, a jelly, or flakes at room temperature and melts and is a liquid when the temperature exceeds the melting point.

For example, polyethlene, where the melting point is 120° C. and the initial temperature of thermal decomposition is 400° C., is used as the binder material 3b as a preferred example. The binder material 3b is a solid such as a wax, a jelly, or flakes at room temperature and melts and is a liquid when the temperature exceeds the melting point.

Here, a binder material where the initial temperature of thermal decomposition is lower than the sintering temperature of the inorganic particles 2a is used as the binder material 3b.

The binder material 3b is not limited to polyethlene, any binder with thermoplasticity as a solid at room temperature and where the initial temperature of thermal decomposition is 350° C. or more and less than 750° C. is sufficient, and, for example, polypropylene or the like may be used.

### Mixing Proportions

Precision of the shape of the sinter mold object increases as the filling ratio of the particles which configure the powder material 2 in the sinter mold object increases. Therefore, it is preferable to have mixing proportions where the volume which is taken up by the binder materials 3a and 3b is smaller due to the gaps between the particles which are tightly filled so that the particles are tightly filled in order to increase the precision of the shape of the sinter mold object. Accordingly, the volume ratio of (A) the powder material 2 and (B) the binder materials 3a and 3b is preferable in the range of 7:3 to 9:1. In addition, the volume ratio of (B) the binder material 3a and (C) the binder material 3b is preferable in the range of 8:2 to 9:1.

### Applied Example

The sinter mold material 1 according to the present embodiment is formed by mixing a stainless steel alloy powder as (A) the powder material 2, polycaprolactone diol as (B) the binder material 3a, and polyethlene as (C) the binder material 3b with a volume ratio of (A):(B):(C)=7.5:2.25:0.25.

Here, a solvent may be included in the sinter mold material 1. A water-based solvent, which includes water and an organic solvent such as an aqueous solution of a mineral salt, is preferable as the solvent. It is even more preferable that water is used as the water-base solvent. It is possible to more easily obtain the sinter mold material in paste form where the powder material 2 is uniformly dispersed by a solvent being included in the sinter mold material 1. In addition, since it is easier to spread the sinter mold material in paste form using the solvent, it is possible for the layers (the mold layers) for layering of the sinter mold material to be more thinly formed in the layer molding method.

In addition, a water soluble organic solvent may be added into the water-base solvent. For example, there are the examples of alcohols such as methanol, ethanol, butanol, IPA (isopropyl alcohol), N-propyl alcohol, butanol, isobutanol, TBA (tert-butanol), butanediol, ethyl hexanol, and benzyl alcohol, glycol ethers such as 1,3 dioxolane, ethylene glycol dimethyl ether, ethylene glycol dimethyl ether, propylene glycol monomethyl ether, ethylene glycol monomethyl ether, ethylene glycol monomethyl ether, and ethylene glycol monomethyl ether acetate, glycols such as ethylene glycol, diethylene glycol, triethylene glycol, and propylene glycol, ether solvents such as isopropyl ether, methyl cellosolve, cellosolve, butyl cellosolve, dioxane, MTBE (methyl tertiary butyl ether), and butyl carbitol.

Due to a water soluble organic solvent being added, it is possible to more easily obtain the sinter mold material in paste form where the powder material 2 is uniformly dispersed. In addition, since it is easier to spread the sinter mold material in paste form using the solvent, it is possible for the layers (the mold layers) for layering of the sinter mold material to be more thinly formed in the layer molding method.

### Applied Example

The sinter mold material 1 according to the present embodiment is formed by kneading a stainless steel alloy powder as (A) the powder material 2, polyvinyl alcohol as (B) the binder material 3a, polyethlene as (C) the binder material 3b, and a mixture liquid of water and tetrahydrofuran as (D) the water-based solvent with a volume ratio of (A):(B):(C):(D)=6.2:045:0.05:3.3.

### Sintering and Molding Apparatus

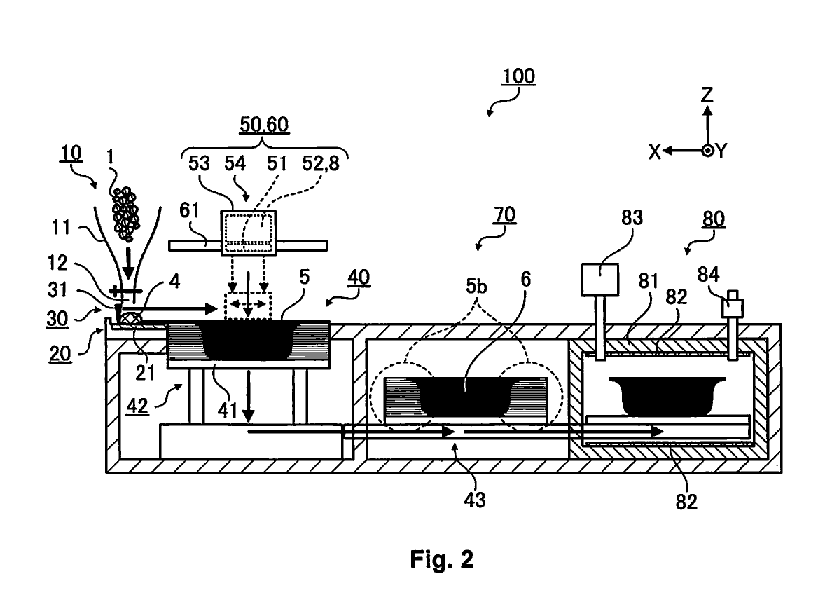

FIG. 2 is a schematic diagram for describing a sintering and molding apparatus 100 according to the present embodiment.

In FIG. 2, the Z axis direction is the up and down direction and the −Z direction is the vertical direction, the Y axis direction is the front and back direction and the +Y direction is the forward direction, the X axis direction is the left and right direction and the +X direction is the leftward direction, and the X-Y plane is a plane which is parallel with the plane on which the sintering and molding apparatus 100 is arranged.

The sintering and molding apparatus 100 is an apparatus which uses the sinter mold material 1 to mold the three dimensional solid model (the sinter mold object) using a layer molding method.

The sintering and molding apparatus 100 is provided with a material supplying section 10, a heating section 20, a spreading section 30, a molding section 40, a drawing section 50, a curing section 60, a finishing section 70, a degreasing and sintering section 80, a control section (which is not shown in the diagram) which controls each of the sections, and the like.

The material supplying section 10 is a section which supplies the sinter mold material 1 which is contained therein to the heating section 20 and is provided with, for example, a hopper 11 as shown in FIG. 2. The hopper 11 supplies the sinter mold material 1 which is contained inside from a material discharging opening 12, which is positioned above the heating section 20, to the heating section 20.

Here, the material supplying section 10 is not limited to this configuration and may be a configuration (which is not shown in the diagram) where, for example, a loading section which loads and heats a cartridge which contains the sinter mold material 1 is provided and the sinter mold material 1 is supplied to the heating section 20 due to the sinter mold material 1 having fluidity by the cartridge which is filled being heated to a temperature which is equal to or higher than the melting points of the binder materials 3a and 3b.

The heating section 20 is provided with a hot plate 21 where the sinter mold material 1 is heated to and maintained at a temperature which is equal to or higher than the melting points of the binder materials 3a and 3b. The sinter mold material 1 which is supplied from the material supplying section 10 becomes a fluid mold material 4 which has fluidity by the binder materials 3a and 3b being melted on the hot plate 21.

The spreading section 30 is provided with a squeegee 31.

The squeegee 31 is a long and thin plate body which extends in the Y axis direction and which is provided to be able to move in the X axis direction, and it is possible for the fluid mold material 4 to be thinly spread by the fluid mold material 4 being moved over the X-Y plane so as to be pushed in the −X direction.

The spreading section 30 spreads the fluid mold material 4 on a stage 41 which is provided in the molding section 40 and forms a mold layer 5.

Here, the method for thinly spreading the fluid mold material 4 is not limited to the method of spreading using the squeegee 31. For example, a method of spreading by pressurizing using air, a method of spreading using centrifugal force by rotating a stage which is provided with a heating section, or the like may be used.

The molding section 40 is provided with the stage 41, a stage raising and lowering mechanism 42 which raises and lowers the stage 41 in the Z axis direction, and the like. At an initial position where the stage 41 is positioned on the same plane (the same height) as the hot plate 21, the stage 41 configures the X-Y plane over which the fluid mold material 4 is spread using the squeegee 31.

The stage 41 is maintained at room temperature, and the fluid mold material 4 which is spread on the stage 41 loses fluidity as the temperature becomes less than the melting points of the binder materials 3a and 3b and is layered as the new mold layer 5 on the mold layer 5 which is previously formed. The fluid mold material 4 which is spread may be left or may be cooled so that the temperature becomes less than the melting points of the binder materials 3a and 3b. As the method for cooling, a method of blowing room temperature or cooled air onto the mold layers 5 using a fan or the like or a method of bringing the mold layer 5 into contact with a cooling plate are possible.

The stage raising and lowering mechanism 42 lowers the stage 41 according to the layer thickness of the mold layer 5 which is spread and formed on the stage 41. By lowering the stage 41, the surface of the mold layer 5 is positioned on the same plane (same height) as the hot plate 21, and the X-Y plane, where the fluid mold material 4 is spread using the squeegee 31 and is layered as the mold layer 5, is configured again.

The drawing section 50 is provided with a discharge head 51, a cartridge loading section 52, a carriage 53, a carriage moving mechanism 54 (which is not shown in the diagram), and the like.

The discharge head 51 is provided with a nozzle (which is not shown in the diagram) which discharges ultraviolet ray curable ink (UV ink 8) as “liquid droplets” using an ink jet system onto the mold layer 5 on the stage 41.

The cartridge loading section 52 is loaded with an ink cartridge which contains the UV ink 8 and supplies the UV ink 8 to the discharge head 51.

The carriage 53 is mounted with the discharge head 51 and the cartridge loading section 52 (that is, an ink cartridge) and is moved on the upper surface of the stage 41 using the carriage moving mechanism 54.

The carriage moving mechanism 54 has an X-Y axis linear transporting mechanism and moves (scans) the carriage 53 over the X-Y plane.

The drawing section 50 forms a desired image (an image which reflects the cross sectional shape of the sinter mold object) on the mold layer 5 which is spread on the stage 41 using the UV ink 8 due to being controlled by the controlling section. In detail, the control section has image information on each cross sectional layer which configures the sinter mold object which is input in advance, controls the positions over which the discharge head 51 is moved and the timing with which the UV ink 8 is discharged according to the image information, and correspondingly applies the UV ink 8 to each of the mold layers 5.

The curing section 60 is provided with an ultraviolet ray irradiating unit 61 as a light irradiating means which cures the UV ink 8 which is applied to the mold layer 5.

The finishing section 70 is a portion which finishes a mold object 6 by removing a region (a non-mold section 5b), where the UV ink 8 is not applied, in the mold layer and is arranged on the −X side of the molding section 40. The finishing section 70 is provided with an unnecessary portion removal means (which is not shown in the diagrams) such as a cutting knife or a rotating brush and performs finishing treatment with regard to the mold object (the layer object with the mold layers 5) which is transported from the molding section 40 using a transporting mechanism 43.

Here, since it is sufficient if the finishing treatment uses a method of washing away and removing the non-mold section 5b using water or the like in a case where the binder materials 3a and 3b are water soluble, there may be a configuration where a water bath or the like is provided as the unnecessary portion removal means.

The degreasing and sintering section 80 is a portion which degreases the mold object 6 where the non-mold section 5b is removed, which carries out sintering treatment, and which is arranged at −X axis of the finishing section 70. The degreasing and sintering section 80 is provided with a degreasing and sintering furnace 81, a heating heater 82, degreasing gas supply equipment 83, exhaust gas equipment 84, and the like and performed degreasing and sintering treatment with regard to the mold object 6 which is transported from the finishing section 70 using the transporting mechanism 43.

Here, a configuration, where the sintering and molding apparatus 100 is provided with the finishing section 70 and the degreasing and sintering section 80 to be continuous from the molding section 40, is described as an example, but the present invention is not limited to this. For example, the finishing section 70 and the degreasing and sintering section 80 may be separately configured or each of the finishing section 70 and the degreasing and sintering section 80 may be separately configured.

### Sintering and Molding Method

A sintering and molding method where the sinter mold material 1 and the sintering and molding apparatus 100 described above are used will be described next.

The sintering and molding method according to the present embodiment includes the following.

(1) forming the fluid mold material 4 by heating the sinter mold material 1, which includes the inorganic particles 2a and the binder materials 3a and 3b which bond together the inorganic particles 2a, to a temperature which is equal to or higher than the melting points of the binder materials 3a and 3b

(2) spreading the fluid mold material 4 and forming the mold layer 5 by cooling to a temperature which is less than the melting points of the binder materials 3a and 3b

(3) layering the mold layers 5

(4) applying the UV ink 8 to a desired region of the mold layer 5 which is layered

(5) curing the UV ink 8 which is applied to the desired region of the mold layer 5

(6) finishing the mold object 6 by removing a region, where the UV ink 8 is not applied, in the mold layer

(7) carrying out degreasing treatment on the mold object 6

(8) carrying out sintering treatment on the mold object 6

The sintering and molding method will be described below in order with reference to FIG. 2.

Here, from after supplying the sinter mold material 1 to the sintering and molding apparatus 100 to performing sintering treatment of the mold object 6 is performed according to controlling by the control section which is provided in the sintering and molding apparatus 100.

First, the sinter mold material 1, which includes the inorganic particles 2a and the binder materials 3a and 3b, is prepared and is filled into the material supplying section 10 (the hopper 11). It is desirable that the ratios of the inorganic particles 2a and the binder materials 3a and 3b, the particle diameter of the inorganic particles 2a, the distribution of the particles diameters, the volume filling ratio using the inorganic particles 2a, the layer thickness of the mold layer 5 which is formed by spreading, and the like are appropriately set according to the molding specifications of the sinter mold object. In addition, it is desirable that the dispersing of the inorganic particles 2a and the binder materials 3a and 3b is uniform.

Next, the sinter mold material 1 is supplied from the material supplying section 10 to the heating section 20 (the hot plate 21). The amount of the sinter mold material 1 which is supplied to the heating section 20 at one time is controlled to be an amount which is equivalent to one layer of the mold layer 5.

The heating section 20 heats the sinter mold material 1 to a temperature which is equal to or higher than the melting points of the binder materials 3a and 3b using the hot plate 21 and forms the fluid mold material 4 due to the binder materials 3a and 3b being melted.

Next, the fluid mold material 4 is spread on the stage 41 using the spreading section 30. In detail, the sinter mold material 1 (the fluid mold material 4) is pushed and stretched over the surface of the stage 41 by the squeegee 31, which abuts with the +X side of the sinter mold material 1 (the fluid mold material 4) which takes on fluidity, being moved in the −X direction.

The stage 41 is maintained at room temperature and the fluid mold material 4 which is spread on the stage 41 is cooled to room temperature. Due to the fluid mold material 4 being cooled to room temperature, the binder materials 3a and 3b set and the mold layer 5 is formed.

The layer thickness of the mold layer 5 is controlled according to the specifications of the spreading using the squeegee 31. In detail, it is desirable that appropriate setting be performed so as to have the desired thickness since the layer thickness of the mold layer 5 changes due to the size of the gap between the lower edge of the squeegee 31 and the X-Y plane (for example, the surface of the stage 41 at an initial position), the movement speed of the squeegee 31, the viscosity of the fluid mold material 4, and the like.

Next, the drawing section 50 forms a desired image on the mold layer 5, which is formed on the stage 41, using the UV ink 8. In detail, the UV ink 8 is applied to positions which correspond to the cross sectional shape of the sinter mold object by the UV ink 8 being discharged while the discharge head 51 is moved according to image information on each cross sectional layer which configures the sinter mold object which is input into the control section in advance.

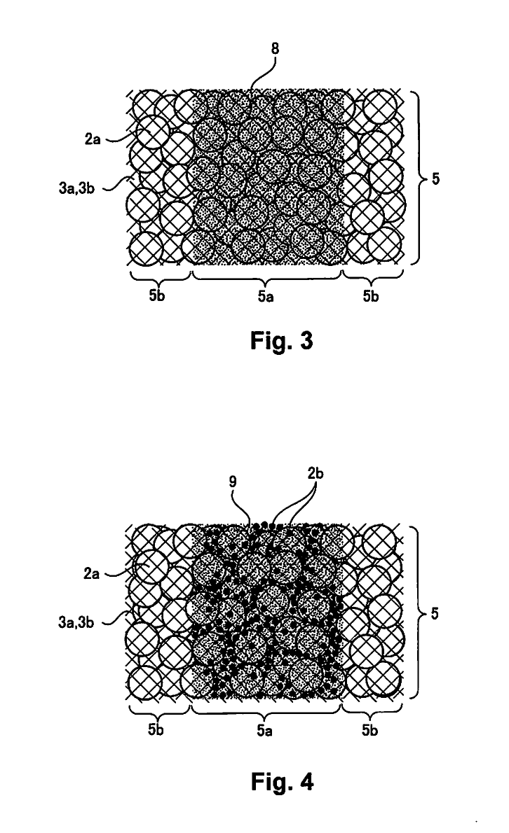

FIG. 3 is a conceptual diagram illustrating a situation where the UV ink 8 is applied to a desired region of the mold layer 5 using the sintering and molding apparatus 100.

Due to the binder materials 3a and 3b which are dispersed in flake form in FIG. 1 being melted and set one time, the volume filling ratio using the inorganic particles 2a is increased and the inorganic particles 2a are substantially uniformly distributed over the entirety of the mold layer 5. The UV ink 8 which is selectively applied to desired positions penetrates the region which includes the particles 2a and the binder materials 3a and 3b as shown in FIG. 3 and a mold section 5a is formed.

Next, the curing section 60 cures the UV ink 8 which is applied to the mold layer 5. In detail, the mold section 5a is cured by ultraviolet rays being irradiating onto the mold layer 5 using the ultraviolet ray irradiating unit 61 and the UV ink 8 which is applied to the mold layer 5 being cured after the carriage 53 retreats from above the stage 41.

Here, in order to maintain interface joining strength with the UV ink 8 which is applied to the mold layer 5 which is layered next, irradiating of ultraviolet rays and curing to the extent that photo-polymerization is not complete is preferable when curing the UV ink 8.

In addition, the sintering and molding apparatus 100 may be configured so that the ultraviolet ray irradiating unit 61 is mounted in the carriage 53 and there may be a method of irradiating of ultraviolet rays and curing while the UV ink 8 is being applied.

Next, the stage raising and lowering mechanism 42 lowers the stage 41 according to the layer thickness of the mold layer 5 which is formed by being spread on the stage 41. Due to the stage 41 being lowered, the surface of the mold layer 5 is positioned on the same surface of the hot plate 21 and an X-Y plane, where the fluid mold material 4 is spread using the squeegee 31 and is layered as the mold layer 5, is configured again.

After this, from supplying the sinter mold material 1 from the material supplying section 10 to the heating section 20 to lowering of the stage 41 is repeated and the mold layer 5 is layered. That is, the second time onward of the mold layer 5 is layered on the mold layer 5 which is previously formed

Here, there may be a method where forming of the mold layer 5 by spreading the fluid mold material 4 is performed at a location other than on the stage 41 and the mold layer 5 is layered by being sequentially transferred to the stage 41.

If the layered is completed so that the layering of the mold layers 5 reaches a height which corresponds to the molding of the mold object 6, the final product is taken out from the molding section 40 and the mold object 6 is finished. In detail, the mold object 6 is finished by the mold object (the layer object with the mold layers 5) being transported from the molding section 40 to the finishing section 70 using the transporting mechanism 43 and the non-mold section 5b where the UV ink 8 is not applied being removed using the unnecessary portion removal means.

Next, the mold object 6 which is finished is moved to the degreasing and sintering section 80 and degreasing treatment is carried out. In detail, first, the mold object 6 is transported from the finishing section 70 to an inner section of the degreasing and sintering furnace 81 using the transporting mechanism 43 and degreasing of the mold object 6 is performed. Degreasing is performed with an aim of finally heating and decomposing the binder materials 3a and 3b and the UV ink 8, and degreasing of the binder material 3a progresses in the degreasing by carrying out heat treatment in a temperature range where degreasing of the binder material 3a starts and which is less than the initial temperature of thermal decomposition of the binder material 3b (a preferable example is a temperature (300° C.) which exceeds the initial temperature of thermal decomposition of polycaprolactone diol (200° C.)). The decomposed components which are generated due to the thermal decomposition of the binder 3a is discharged from the exhaust gas equipment 84 using a gas for degreasing which is supplied from the degreasing gas supply equipment 83.

Next, sintering treatment is performed on the mold object 6 where the binder material 3a is degreased. In detail, sintering of the inorganic particles 2a progresses by heating at a temperature range which is equal to or more than the sintering temperature of the inorganic particles 2a and which is less than the melting point of the inorganic particles 2a (a preferable example is performing heat treatment at 1300° C. which is equal to or more than a temperature which exceeds the initial temperature of thermal decomposition of polyethlene (400° C.) and is a temperature where stainless steel alloy powder is sintered). The decomposed components, which are generated due to the thermal decomposition of the binder 3b and the UV ink 8 at this temperature, is discharged from the exhaust gas equipment 84 using a gas for degreasing which is supplied from the degreasing gas supply equipment 83. A desired sinter mold object is obtained by completing sintering of the inorganic particles 2a.

As described above, it is possible for the following effects to be obtained according to the sinter mold material, the sintering and molding method, the sinter mold object, and the sintering and molding apparatus of the present embodiment.

The sinter mold material 1 includes the binder materials 3a and 3b which bond together the inorganic particles 2a. For this reason, it is easy for the sinter mold material 1 to be spread in the state where scattering of the inorganic particles 2a is suppressed at a temperature which is equal to or more than the melting points of the binder material 3a and the binder material 3b. That is, it is possible for the layers (the mold layers) for layering of the sinter mold material 1 to be thinly formed. In addition, it is possible to mold the sinter mold object by the mold object being molded and the mold object being degreased and sintered using the layer molding method of molding by layering the mold layers. As a result, it is possible to more productively mold the sinter mold object with high precision compared to a molten deposit method.

In addition, since the initial temperature of thermal decomposition of the binder material 3b is higher than the initial temperature of thermal decomposition of the binder material 3a, it is possible to provide heating within a wider temperature width with regard to the sinter mold material 1 during molding of the sinter mold object by degreasing and sintering the mold object 6. In more detail, it is possible to perform sintering and molding while suppressing changes in shape and breakages since it is possible for the thermal decomposition of the binders to progress in steps over a temperature range which is wider from heating where degreasing starts to heating where sintering is performed at a higher temperature.

In more detail, since the initial temperature of thermal decomposition of the binder material 3a is 50° C. or more and less than 350° C., it is possible for degreasing where the binder material 3a is the target to progress by heating the sinter mold material 1 within a temperature range which exceeds the initial temperature of thermal decomposition of the binder material 3a and is less than the initial temperature of thermal decomposition of the binder material 3a (350° C. or more and 750° C. or less) (a preferable example is heating of the sinter mold material 1 at a temperature in a temperature range which exceeds the initial temperature of thermal decomposition of polycaprolactone diol (200° C.) up to the initial temperature of thermal decomposition of polyethlene (400° C.)). That is, it is possible for the degreasing of a portion of the binders (the binder material 3a) to progress at a temperature which is before sintering of the inorganic particles 2a starts. In addition, it is possible to increases the extent of degreasing while suppressing changes in shape and breakages since the inorganic particles 2a are supported by the binder material 3b where thermal decomposition does not start in this temperature range.

In addition, since the initial temperature of thermal decomposition of the binder material 3b is 350° C. or more and less than 750° C., it is possible for degreasing where the binder material 3b is the target to progress by heating the sinter mold material 1 at a temperature which exceeds the initial temperature of thermal decomposition of the binder material 3b (a preferable example is performing heating of the sinter mold material 1 at a temperature which exceeds the initial temperature of thermal decomposition of polyethlene (400° C.)). In addition, it is possible for degreasing where the binder material 3b is the target to be performed in parallel at a temperature (or in the vicinity of a temperature) where sintering of the inorganic particles 2a starts since the initial temperature of thermal decomposition of the material binder 3b is a relative high temperature of 350° C. or more and less than 750° C. As a result, it is possible to perform sintering and molding while suppressing changes in shape and breakages.

It is possible to more easily obtain the sinter mold material 1 in paste form where the inorganic particles 2a are uniformly dispersed in a case where a solvent is included in the sinter mold material 1. In addition, since it is easier to spread the sinter mold material 1 in paste form using the solvent, it is possible for the layers (the mold layers) for layering of the sinter mold material 1 to be more thinly formed in the layer molding method. As a result, it is possible to perform sintering and molding with higher precision.

That is, according to the sinter mold material, the sintering and molding method, and the sintering and molding apparatus of the present embodiment, it is possible for the sinter mold material 1 to be easily spread in the state where scattering of the inorganic particles 2a is suppressed and it is possible for the mold layer 5 for layering of the sinter mold material 1 to be more thinly formed. In addition, it is possible to mold the sinter mold object by the mold object 6 being molded and the mold object 6 being degreased and sintered using the layer molding method of molding by layering the mold layers 5. It is possible to perform sintering and molding while suppressing changes in shape and breakages since it is possible for the thermal decomposition of the binders to progress in steps over a temperature range which is wider from heating where degreasing starts to heating where sintering is performed at a higher temperature. As a result, it is possible to more stably mold the sinter mold object with high precision and more productivity compared to a molten deposit method or the like.

### Embodiment 2

A sintering and molding method and a sinter mold object according to embodiment 2 will be described next. Here, in the description, the same reference numerals are used for the configuration parts which are the same as the embodiment described above and overlapping description is omitted.

Embodiment 2 is where “liquid droplets” includes “second organic particles”. The sintering and molding method of embodiment 2 only differs with regard to the point where UV ink 9 is used as the UV ink 8 which is used in embodiment 1 and the other configuration parts are the same as the sintering and molding method of embodiment 1.

FIG. 4 is a conceptual diagram illustrating a situation where the UV ink 9 is applied as the “liquid droplets” which include second inorganic particles 2b as the “second organic particles” in contrast to FIG. 3 which illustrates a situation where the UV ink 8 is applied to a desired region of the mold layer 5.

The UV ink 9 is ultraviolet ray curable ink where the inorganic particles 2b are included in the UV ink 8.

It is preferable that the metal particles or ceramic particles, which are the same as the inorganic particles 2a where the average particle diameter is smaller than the inorganic particles 2a, are used as the inorganic particles 2b. It is preferable that the inorganic particles 2b have substantially a spherical shape where the average particle diameter is 0.001 μm or more and 10 μm or less and it is more preferable that the average particle diameter is 0.001 μm or more and 5 μm or less. In addition, it is preferable for the inorganic particles 2b to be closer to a true spherical shape.

The inorganic particles 2b where the particle diameter is smaller compared with the inorganic particles 2a enters into the gaps between the inorganic particles 2a along with the UV ink 9 penetrating into the inside of the mold layers 5 as shown in FIG. 4.

Beyond this, the same processes as the sintering and molding method of embodiment 1 is performed and a sinter mold object is obtained.

It is possible for the following effects to be obtained in addition to the effects of the embodiment described above according to the sintering and molding method and the sinter mold object of the present embodiment.

The UV ink 9 which is applied to a desired region of the mold layer 5 includes the inorganic particles 2b. That is, since the UV ink 9 which includes the inorganic particles 2b is applied to a desired region of the mold layer 5 which is formed in the desired cross sectional shape of the mold object, the mold object 6 which is degreased and sintered is configured to include the inorganic particles 2b in addition to the inorganic particles 2a. That is, it is possible to obtain the mold object 6 where the filling ratio of the inorganic particles is higher compared to the mold object 6 which is configured only by the inorganic particles 2a. As a result, it is possible to obtain a sinter mold object with higher precision since rigidity is higher and changes in dimensions due to sintering are even more suppressed.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A sinter molding material, which is used a molding method which includes applying liquid droplets to a desired region of the sinter mold material and curing the liquid droplets, the sinter mold material comprising:
first inorganic particles;
a first thermoplastic binder which bonds together the first inorganic particles; and
a second thermoplastic binder which bonds together the first inorganic particles,
an initial temperature of thermal decomposition of the second thermoplastic binder being higher than an initial temperature of thermal decomposition of the first thermoplastic binder.

2. The sinter molding material according to claim 1, wherein
the initial temperature of thermal decomposition of the first thermoplastic binder is 50° C. or more and less than 350° C.

3. The sinter molding material according to claim 1, wherein
the initial temperature of thermal decomposition of the second thermoplastic binder is 350° C. or more and 750° C. or less.

4. The sinter molding material according to claim 1, wherein
the first thermoplastic binder is polyvinyl alcohol, polyvinyl pyrrolidone, poly(meth)methyl acrylate, polyvinyl chloride, ethylene and vinyl acetate copolymer, or polycaprolactone diol.

5. The sinter molding material according to claim 1, wherein
the second thermoplastic binder is polyethylene, polypropylene, polytetrafluoroethylene, or polybenzimidazole.

6. The sinter molding material according to claim 1, wherein
the first inorganic particles are metal particles.

7. The sinter molding material according to claim 1, wherein
the first inorganic particles are ceramic particles.

8. The sinter molding material according to claim 1, further comprising a solvent.

9. A sintering and molding method comprising:
forming a fluid mold material by heating a sinter mold material, which includes first inorganic particles, a first thermoplastic binder which bonds together the first inorganic particles, and a second thermoplastic binder which bonds together the first inorganic particles and which has an initial temperature of thermal decomposition which is higher than an initial temperature of thermal decomposition of the first thermoplastic binder, to a temperature which is equal to or more than a melting point of the first thermoplastic binder and a melting point of the second thermoplastic binder;
forming a mold layer by spreading the fluid mold material;
layering the mold layer;
applying liquid droplets to a desired region on the mold layer;
forming a mold cross sectional pattern by curing the liquid droplets which are applied to the desired region on the mold layer;
finishing a mold object by removing a region, where the liquid droplets are not applied, in the mold layer;
carrying out heat treatment on the mold object at a temperature which is less than the initial temperature of thermal decomposition of the second thermoplastic binder; and
carrying out sintering treatment on the mold object.

10. The sintering and molding method according to claim 9, wherein
the liquid droplets include second inorganic particles.

11. The sintering and molding method according to claim 10, wherein
the second inorganic particles are metal particles which are the same as the first inorganic particles.

12. The sintering and molding method according to claim 10, wherein
the second inorganic particles are ceramic particles which are the same as the first inorganic particles.

13. A sintering and molding apparatus comprising:
a heating section configured to form a fluid mold material by heating a sinter mold material, which includes first inorganic particles, a first thermoplastic binder which bonds together the first inorganic particles, and a second thermoplastic binder which bonds together the first inorganic particles and which has an initial temperature of thermal decomposition which is higher than an initial temperature of thermal decomposition of the first thermoplastic binder, to a temperature which is equal to or more than a melting point of the first thermoplastic binder and a melting point of the second thermoplastic binder;
a spreading section configured to form a mold layer by spreading the fluid mold material;
a molding section configured to layer the mold layer;
a drawing section configured to apply liquid droplets to a desired region on the mold layer which is layered; and
a curing section configured to form a mold cross sectional pattern by curing the liquid droplets which are applied to the desired region on the mold layer.

14. The sintering and molding apparatus according to claim 13, further comprising
a finishing section configured to finish the mold object by removing a region, where the liquid droplets are not applied, in the mold layer, and
a sintering section configured to carry out heating and sintering treatment on the mold object.

15. A sinter mold object which is molded using the sinter mold material according to claim 1.

16. A sinter mold object which is molded using the sintering and molding method according to claim 9.

17. A sinter mold object comprising:
first inorganic particles which are included beforehand in a sinter mold material which is to be layered; and
second inorganic particles which are included in liquid droplets which are applied to the sinter mold material which is layered.
